(19) United States
(12) Patent Application Publication
(10) Pub. No.: US 2013/0179209 A1
(43) Pub. Date: Jul. 11, 2013

(54) INFORMATION MANAGEMENT SERVICES

(71) Applicant: Steven J. Milosevich, Trumbull, CT (US)

(72) Inventor: Steven J. Milosevich, Trumbull, CT (US)

(21) Appl. No.: 13/346,914

(22) Filed: Jan. 10, 2012

(51) Int. Cl. G06Q 10/06; G06Q 10/02

(52) U.S. Cl. 705/7.18

(57) ABSTRACT

Implementing information management services (IMS) includes providing an electronic calendar configured by an end user, along with contacts specified for the end user, receiving a selection of an event via the electronic calendar, and receiving a selection of prospective participants for the event from the contacts listed. The IMS also includes accessing a database of preferences supplied by the prospective participants, searching a database of event-related resources using characteristics of the event including the preferences of the prospective participants, and determining availability of services corresponding to the event-related resources. The IMS further includes selecting at least one of the event-related resources determined to have availability, accessing contact information for the prospective participants, transmitting an invitation to the prospective participants using the contact information, and reserving the services associated with the event-related resources for the end user and each of the prospective participants who have accepted the invitation.

### FIELD OF THE INVENTION

The subject invention relates to data processing, and more particularly, to information management services.

### BACKGROUND

Individuals are inundated with a wealth of information, due in part to advances in the Internet and the increasing popularity of different types of social media available to these individuals. In addition, work-related responsibilities and personal engagements generate their own sources of information overload for these individuals. For example, making travel arrangements can be a complex task depending on factors such as the number of travel-related resources involved in the planning (e.g., connecting flights, vehicle rentals, lodging, etc.) or the number of travelers in a group for which the trip is planned. Coordinating the travel plans for a group of travelers generally involves the manual entry of each participant's name and personal information into a reservation system that is necessary to secure a booking. When a future trip is planned, the same manual entry is generally required. Similar issues are known to other responsibilities of individuals, such as work-related and personal tasks.

### SUMMARY OF THE INVENTION

In one exemplary embodiment of the present invention a system for implementing information management services is provided. The system includes a computer processor and logic executable by the computer processor. The logic is configured to implement a method. The method includes providing, via a user interface, an electronic calendar configured by an end user, along with contacts specified for the end user and selectable options, receiving a selection of an event via the electronic calendar, and receiving a selection of prospective participants for the event from the contacts listed via the user interface. The method also includes accessing a database of preferences supplied by the prospective participants, searching at least one database of event-related resources using characteristics of the event including the date of the event and the preferences of the prospective participants, determining availability of services corresponding to the event-related resources, and selecting at least one of the event-related resources determined to have availability. The method further includes accessing contact information for the prospective participants, and transmitting an invitation to the prospective participants using the contact information, and reserving the services associated with the event-related resources for the end user and each of the prospective participants who have accepted the invitation.

In another exemplary embodiment of the present invention, a method for implementing information management services is provided. The method includes providing, via a user interface, an electronic calendar configured by an end user, along with contacts specified for the end user and selectable options, receiving a selection of an event via the electronic calendar, and receiving a selection of prospective participants for the event from the contacts listed via the user interface. The method also includes accessing a database of preferences supplied by the prospective participants, searching at least one database of event-related resources using characteristics of the event including the date of the event and the preferences of the prospective participants, determining availability of services corresponding to the event-related resources, and selecting at least one of the event-related resources determined to have availability. The method further includes accessing contact information for the prospective participants, and transmitting an invitation to the prospective participants using the contact information, and reserving the services associated with the event-related resources for the end user and each of the prospective participants who have accepted the invitation.

In yet another exemplary embodiment of the present invention a computer program product for implementing information management services is provided. The computer program product includes a storage medium embodied with computer-readable program instructions, which when executed by a computer, cause the computer to implement a method. The method includes providing, via a user interface, an electronic calendar configured by an end user, along with contacts specified for the end user and selectable options, receiving a selection of an event via the electronic calendar, and receiving a selection of prospective participants for the event from the contacts listed via the user interface. The method also includes accessing a database of preferences supplied by the prospective participants, searching at least one database of event-related resources using characteristics of the event including the date of the event and the preferences of the prospective participants, determining availability of services corresponding to the event-related resources, and selecting at least one of the event-related resources determined to have availability. The method further includes accessing contact information for the prospective participants, and transmitting an invitation to the prospective participants using the contact information, and reserving the services associated with the event-related resources for the end user and each of the prospective participants who have accepted the invitation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a block diagram of a system upon which information management services may be implemented in accordance with an embodiment;

FIGS. 2A-2B are flow diagrams describing a process for implementing information management services in accordance with an embodiment;

FIG. 3 is a user interface screen viewable by an end user of the information management services in accordance with an embodiment;

FIG. 4 is a user interface screen depicting a calendar of events configured by an end user of the information management services in accordance with an embodiment;

FIG. 5 is a user interface screen depicting events listed for a date selected from the calendar of events shown in FIG. 4 in accordance with an embodiment;

FIG. 6 is a user interface screen depicting contact data related to a contact selected from the events listed in the calendar of events in accordance with an embodiment;

FIGS. 7-18 are user interface screens depicting a process of booking an event listed as a calendar event in accordance with an embodiment;

FIG. 19 is a user interface screen for managing users of the information management services in accordance with an embodiment; and

FIG. 20 is a user interface screen listing sample selectable preferences for use in implementing the information management services in accordance with an embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, information management services are provided. The information management services provide a comprehensive and centralized facility for creating, organizing, and synchronizing a variety of different types of information. The information management services offer a web-based user interface for guiding end users through event- and/or date-driven planning, scheduling, and reservation processes. In addition, end users can plan and book meetings, events, trips, and related resources for multiple companions. Post-booking services may also be accessed through the user interface. The information management services also offer subscription-based services to resource providers. For example, in the travel industry, resource providers may include transportation service providers (e.g., airlines, bus lines, trains, sea craft, etc.), lodging providers (e.g., hotels, motels, bed and breakfast establishments, etc.), event providers (e.g., where the events include functions, such as business or personal seminars, weddings, concerts, meetings, etc.), and related entities, such as travel agencies. These and other features of the information management services will now be described.

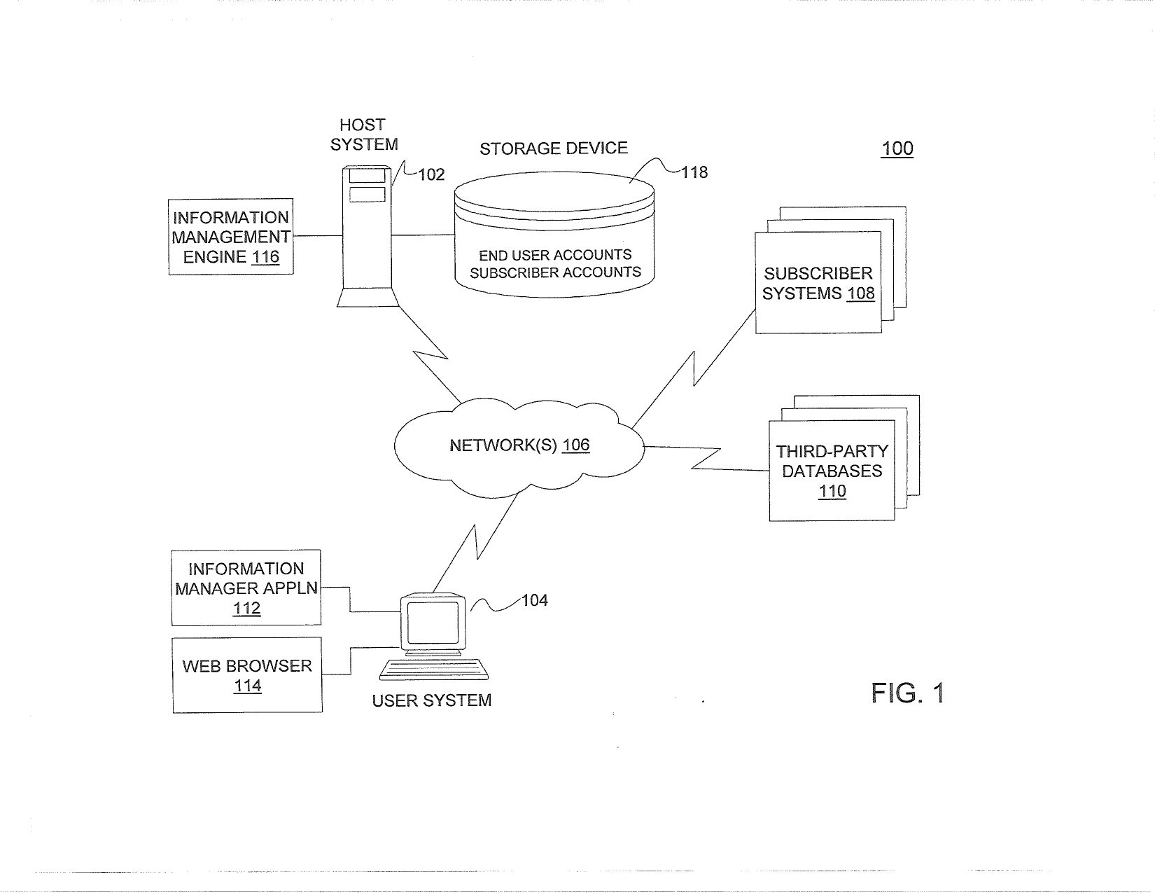

Turning now to FIG. 1, a system 100 upon which the information management services may be implemented will now be described in an exemplary embodiment. The system 100 includes a host system 102 in communication with a user system 104, subscriber systems 108, and third-party databases 110 over one or more networks 106.

The host system 102 may be implemented as a high-speed computer processing device (e.g., a mainframe computer) capable of handling a high volume of activities conducted between the host system 102 and network entities, such as the user system 104, subscriber systems 108, and third-party databases 110. The host system 102 may be operated by an enterprise or organization implementing the exemplary information management services described herein. The host system 102 may operate as a web server including a web site for generating end user accounts and subscription accounts to the information management services. The host system 102 may also operate as an application server including one or more applications for providing the information management services described herein. These one or more applications are collectively referred to herein as information management engine 116. In an exemplary embodiment, the host system 102 provides a centralized facility, e.g., via a web site and user interface, for enabling end users to plan and book events, meetings, trips, etc., and the centralized facility also enables resource providers to provide their availability and other relevant information to interested end users.

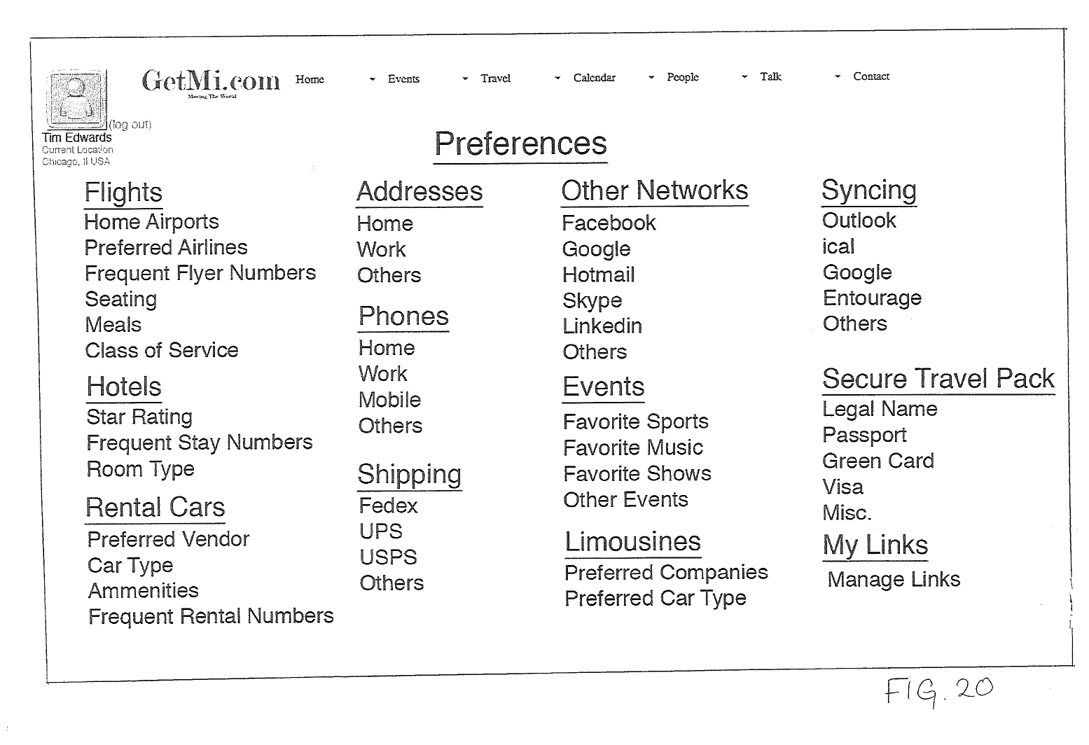

In an embodiment, the host system 102 is communicatively coupled to a storage device 118, which stores accounts for the end users of the information management services, as well as accounts established for subscribers of the information management services, and related data. End user accounts and subscriber accounts created via the information management engine 116 may include identification data (e.g., name, address, end user identification, etc.), billing information (if the services are provided for a fee), and report information from activities conducted via the host system 102, such as statistical data captured for past user searches that enable service providers to understand end user interests and preferences. Other information that may be stored in the storage device 118 may include end user preferences for each end user of the information management services, a user interface screen with sample user preferences is shown and described in FIG. 20. In addition, information stored may include electronic calendars for end users of the information management services.

While the storage device 118 is shown in FIG. 1 as a separate physical device from the host system 102, it will be understood that the storage device 112 may be integrated into the host system 102 as internal storage (e.g., as a hard disk drive) or may be communicatively coupled to the host system 102 over a network, such as networks 106.

The user system 104 may be any type of general-purpose computer device capable of sending and receiving information over a network. For example, the user system 104 may be a desktop computer or laptop, or may be a wireless device, such as a smart phone or personal digital assistant. The user system 104 may be operated by an end user of the information management services. In one embodiment, the user system 104 may be host-attached computer coupled to a server computer over a network (e.g., a local area network or intranet). In a business context, the user system 104 may be operated by an employee of the business who utilizes the information management services to schedule, plan and book events for one or more employees of the business.

In one embodiment, the user system 104 includes an information manager application 112 that includes email or messaging capabilities, a calendar application, and contacts folder. In the above-described business context, the information manager application 112 may be implemented by the server for each of the user systems coupled to the server over the network.

As shown in FIG. 1, the user system 104 also includes a web browser 114. The end user may access the web server of the host system 102 over the networks 106 to initiate the information management services. For example, the end user types in a uniform resource locator (URL) of the information management services provided by the host system 102, and the information management engine 116 establishes a secure profile for the end user with user-selected settings. The host system 102 provides a downloadable application (i.e., the information manager application 112, which may be, e.g., an applet) that enables the end user to perform aspects of the information management services. In one embodiment, the information manager application 112 is provided as a downloadable application to a mobile device where, e.g., the user system 104 is a smart phone or personal digital assistant. Alternatively, most of the functionality of the email or messaging capabilities, a calendar application, and contacts folder may be performed by the information management engine 116.

As indicated above, the entity implementing the host system 102 may extend the information management services to resource providers. In one embodiment, a resource provider (e.g., an airline) registers or subscribes to the information management services via the host system 102, and provides resource information to the host system 102. For example, using the airline example above, the host system 102 may provide the host system 102 with restricted access to its databases of flight information, ticket costs, availability (i.e., reservation system), and airport/gate maps. The subscribing resource providers are shown generally in FIG. 1 as 108. The subscriber systems 108 may be implemented in part by high-speed computer processors or mainframe computers. In return for registration of the information management services, the subscriber systems 108 may be given a higher preference or status in returning search results for travel resources to end users, as compared with a non-registered travel resource, such as a third-party database 110.

In one embodiment, the third-party databases 110 are implemented by resource providers. For example, in the travel industry, third-party databases 110 may be implemented by transportation service providers, lodging providers, event providers, etc. who are not subscribers of the information management services. The host system 102 searches third-party databases 110 that are accessible via the Internet. In another embodiment, the third-party databases 110 may store supplemental information, such directions, maps, weather, attractions or destination-based activities or functions, to name a few.

The networks 106 may be any type of known networks in the art. For example, the networks 106 may be a combination of public (e.g., Internet), private (e.g., local area network, wide area network, virtual private network), and may include wireless and wireline transmission systems (e.g., satellite, cellular network, terrestrial networks, etc.).

As indicated above, the information management services may be initiated for a destination or may be event-based. The information management engine 116 provides a user interface for guiding an end user through the process.

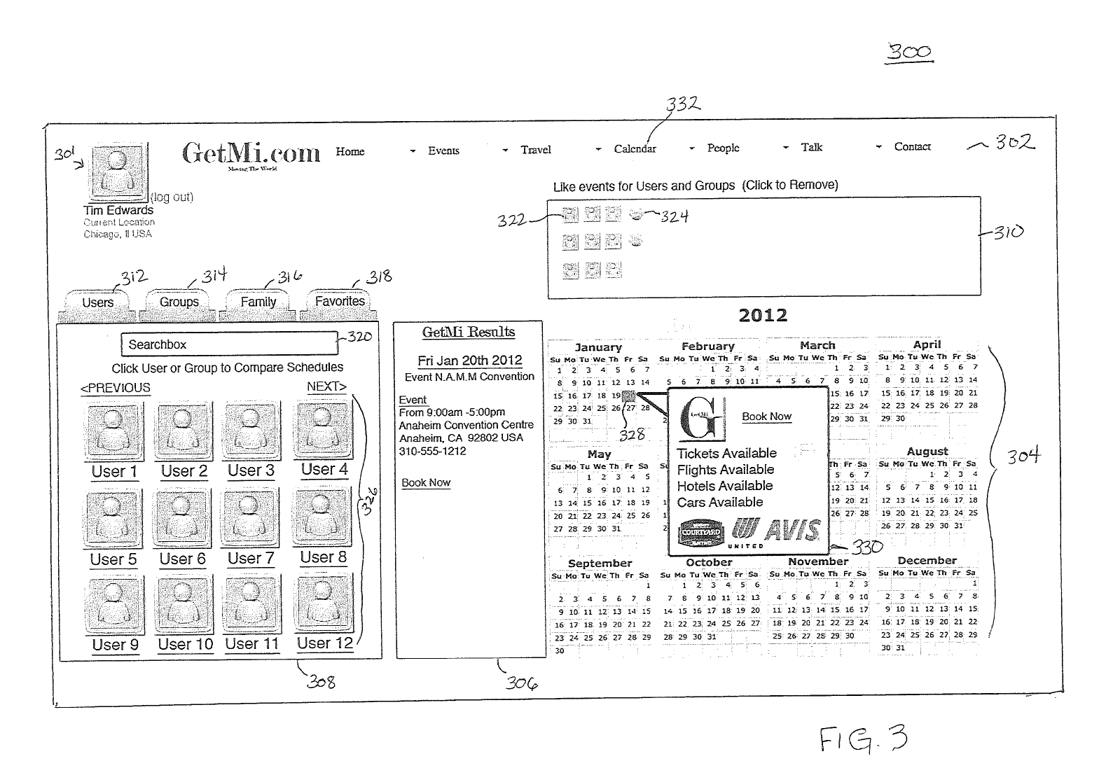

Once the end user has logged in to his/her account, the end user may perform various functions. A user interface screen 300 shown in FIG. 3 depicts a toolbar 302 with selectable features, as well as end user information 301. The user interface screen 300 of FIG. 3 assumes that the end user has previously set up his/her contacts, groups, and has scheduled items within his/her electronic calendar. The end user information 301 may include an image or icon associated with the end user, as well as the end user's name and location.

The user interface screen 300 also depicts a twelve-month calendar 304. The end user may scroll over a particular date (e.g., a date highlighted as 328) on the calendar 304 and any events scheduled for that selected date 328 are shown in a results window 306. In addition, a booking window 330 is revealed for the selected date 328, which displays a number of available booking options for the end user, such as ticketing, flights, hotels, car rentals, etc., with a link that enables the end user to be transferred to a separate window, as will be described further herein.

The end user may view information regarding other end users and groups who share a common event with the end user. As shown in FIG. 3, an event window 310 lists the end users 322 and groups 324 who have the highlighted event (shown in the results window 306) from date 328 scheduled into their calendars. The information management engine 116 may use data associated with the event scheduled in the end user's calendar to search a database of calendar events for contacts associated with the end user to find matching events/times. In one embodiment, the information management engine 116 creates an index of scheduled events or items in all users' calendars and can search these calendars using key words supplied by the end user or from an event selected on the end user's calendar.

The user interface screen 300 also includes a contacts window 308 that lists all contacts 326 associated with the end user. These contacts 326 are also end users of the information management services who have authorized the end user to view their public calendars through the information management engine 116. The end user may select one or more end users 326 to view their respective calendars. In one embodiment, information management engine 116 is configured to link each contact's icon to a corresponding calendar and related information for that contact, and stores any access and viewing permissions granted by the contact to the end user and/or other users. The contacts window 308 also includes users tab 312, groups tab 314, family tab 316, and favorites tab 318.

By selecting the users tab 312, the information management engine 116 enables the end user to view all end users (contacts) 326 entered into the end user's profile (e.g., shown as the users 326 in the contacts window 308). Likewise, by selecting the groups tab 314, the end user is presented with a listing of all groups entered into the end user's profile. The end users and groups may be created by the end user or may be created by an administrator of the information management services and added to the end user's profile. The end user may establish settings for users who are family members using the family tab 316. The favorites tab 318 may be configured to ‘bookmark’ end users, groups, scheduled events, etc., for quick and easy access by the end user.

The information management engine 116 is configured to index calendar entries for items listed in each of the end users' calendars. The contacts window 308 includes a searchbox 320 that enables the end user to search for key words related to scheduled events and end users, as will be described further herein. The information management engine 116 utilizes the index to search terms across multiple calendars associated with contacts known to the end user, subject to permissions granted by the contacts. Thus, the information management services provide a variety of different ways of viewing scheduled events and information.

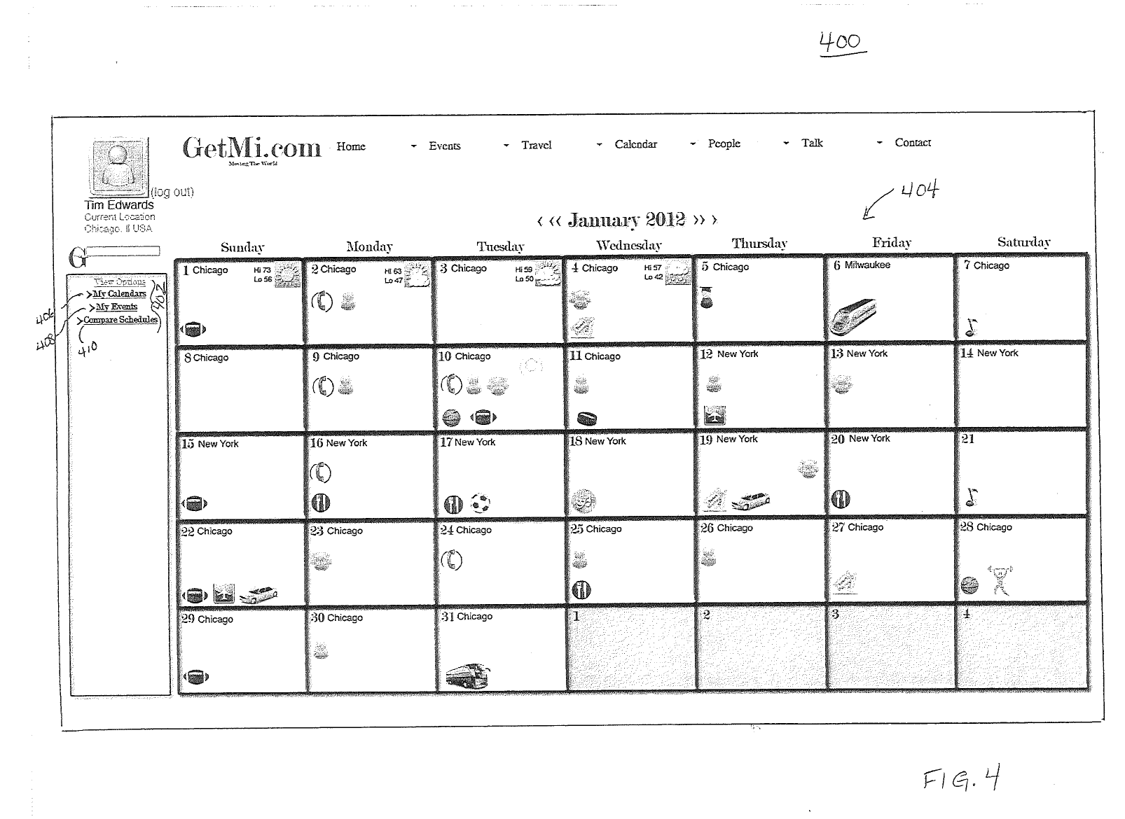

The end user may select a calendar option 332 on the toolbar 302 of FIG. 3, followed by an option to display events for the month of January 2012. The information management engine 116 retrieves the scheduled events stored for the month of January (e.g., from the storage device 118) via a user interface screen 400, and displays the calendar month along with the events, a sample of which is shown in FIG. 4. It will be understood that the events may be displayed as text, images or icons. The calendar 400 may be also display weather data, e.g., where the event scheduled reflects an event that will occur at a location to which the end user is scheduled to be present. The weather data may be retrieved from one of the third-party databases 110.

Various viewing options are provided as a menu 402 of viewing options. As shown in FIG. 4, e.g., the end user may change the view from a monthly calendar 404 to a different calendar (such as a private calendar, public calendar, or event-based calendar, or alternatively display a year-view calendar, week-view calendar, etc.) by selecting “My Calendars” option 406 from the menu 402. Alternatively, the end user may select the option “My Events” 408 to view a listing of all scheduled events, or may select the option “Compare Schedules” 410 to view and compare schedules of other end users.

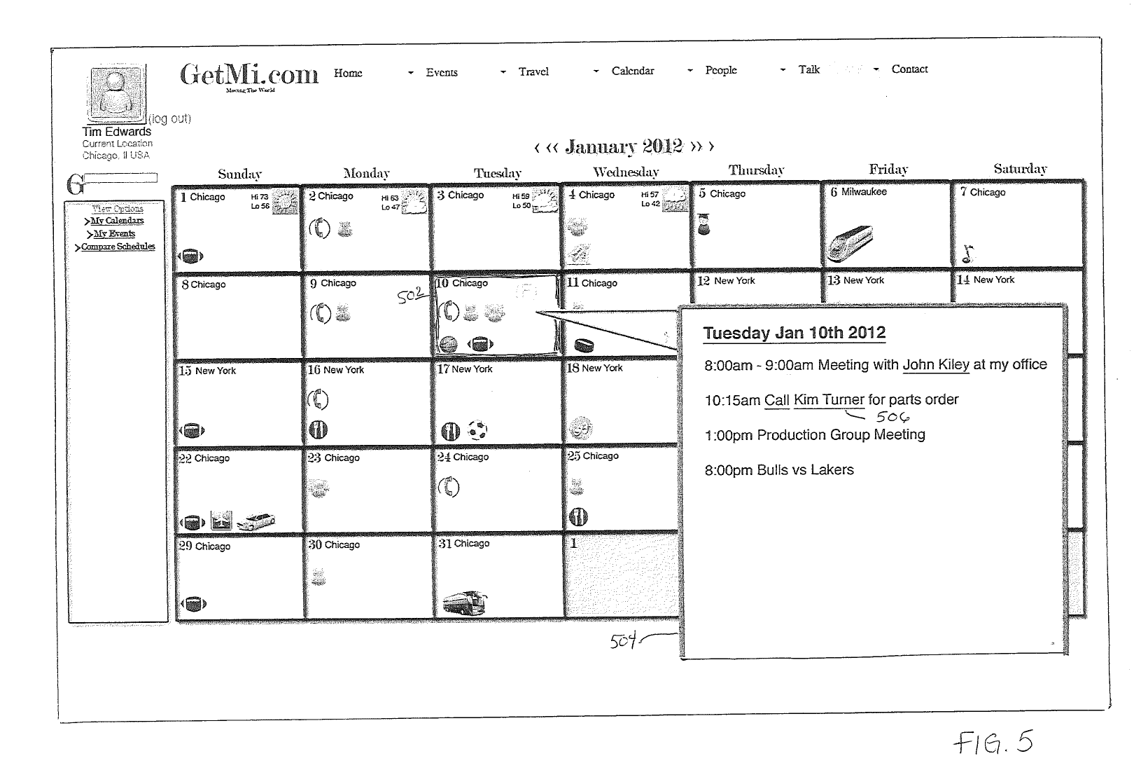

By scrolling over a date in the calendar 404, the end user is presented with a listing of each of the events scheduled for that day. As shown in FIG. 5, the end user has scrolled over Jan. 10, 2012 (shown generally as 502) in FIG. 5, and the information management engine 116 retrieves the scheduled events for that date and presents the events in a day view window 504. The events may include begin and end times, event descriptions, and contacts associated with the events. Event actions, such as “Call Kim Turner” may be displayed as a hyperlink 506 that, upon selection, causes the information management engine 116 to retrieve contact information for the contact and initiate a call to the contact (e.g., using the contact preferences provided by the contact).

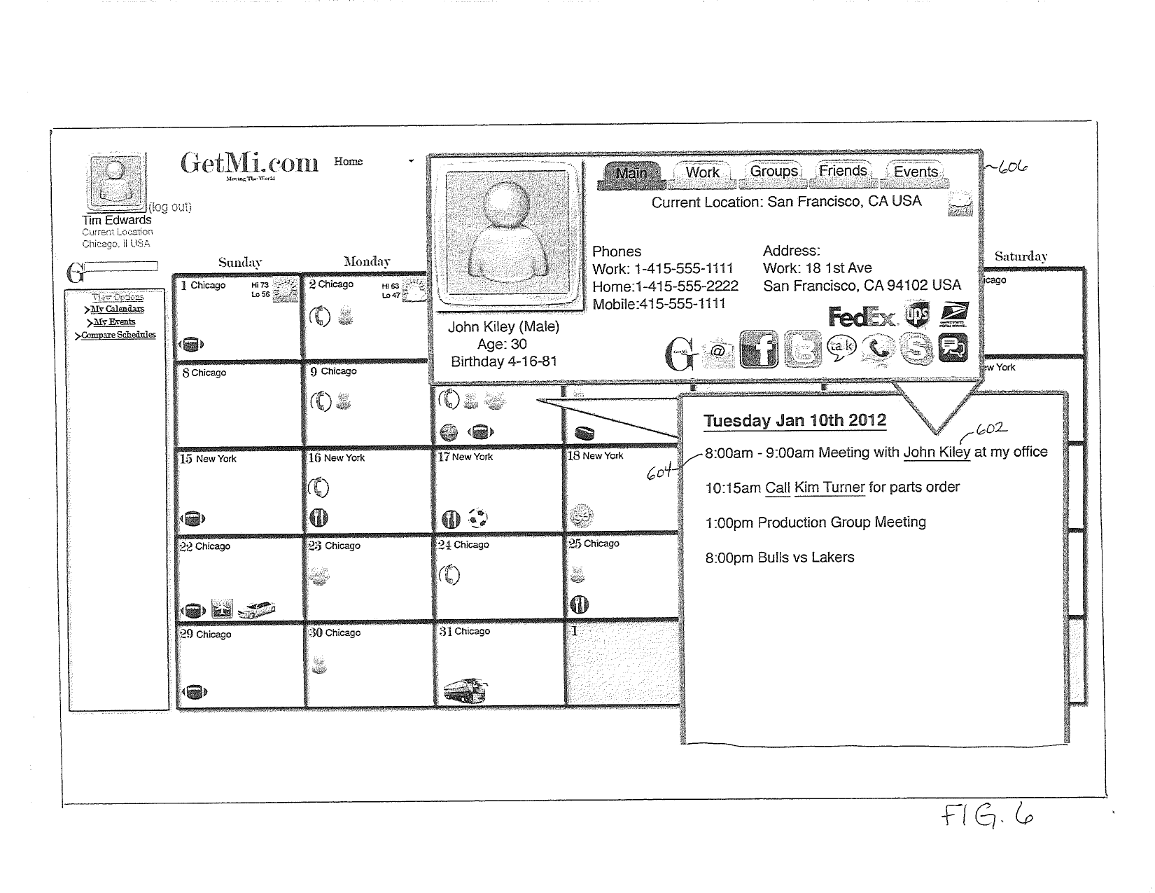

As shown in FIG. 6, the end user has selected a hyperlink 602 for a contact “John Kiley” associated with the event 604. The information management engine 116 retrieves profile information for the selected contact (e.g., from the contact's information stored in the storage device 118 when the contact sets up his/her calendar) and displays the profile information in a contact window 606. The profile information may include contact name, gender, age, birthday, phone numbers, geographic address, and the contact's current location. Other information may be retrieved and displayed, such as preference information provided by the contact (e.g., via the user preferences described in FIG. 20). As shown in FIG. 6, the preferences include method of preferred shipping and available means of contacting the selected contact.

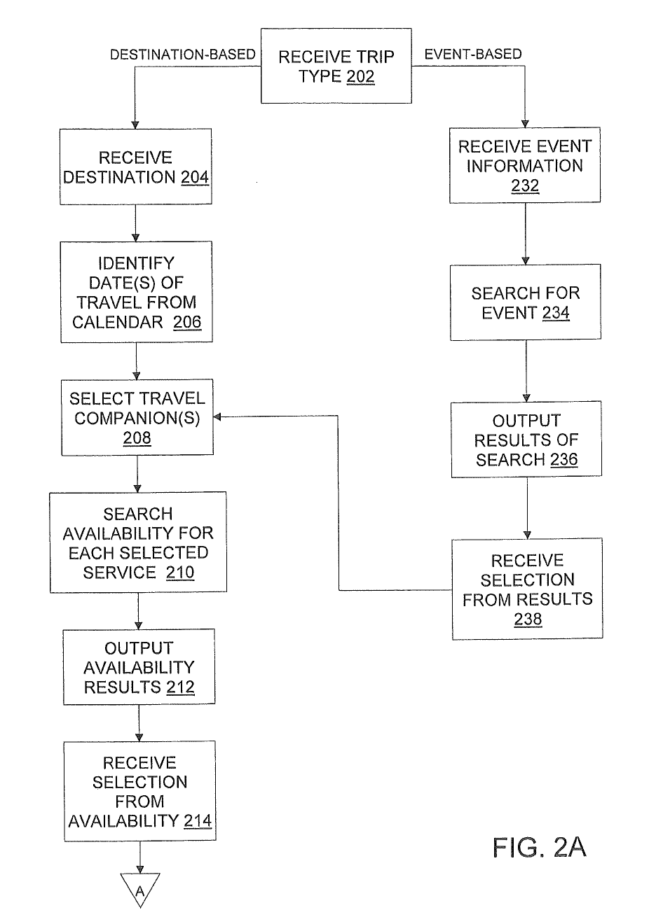

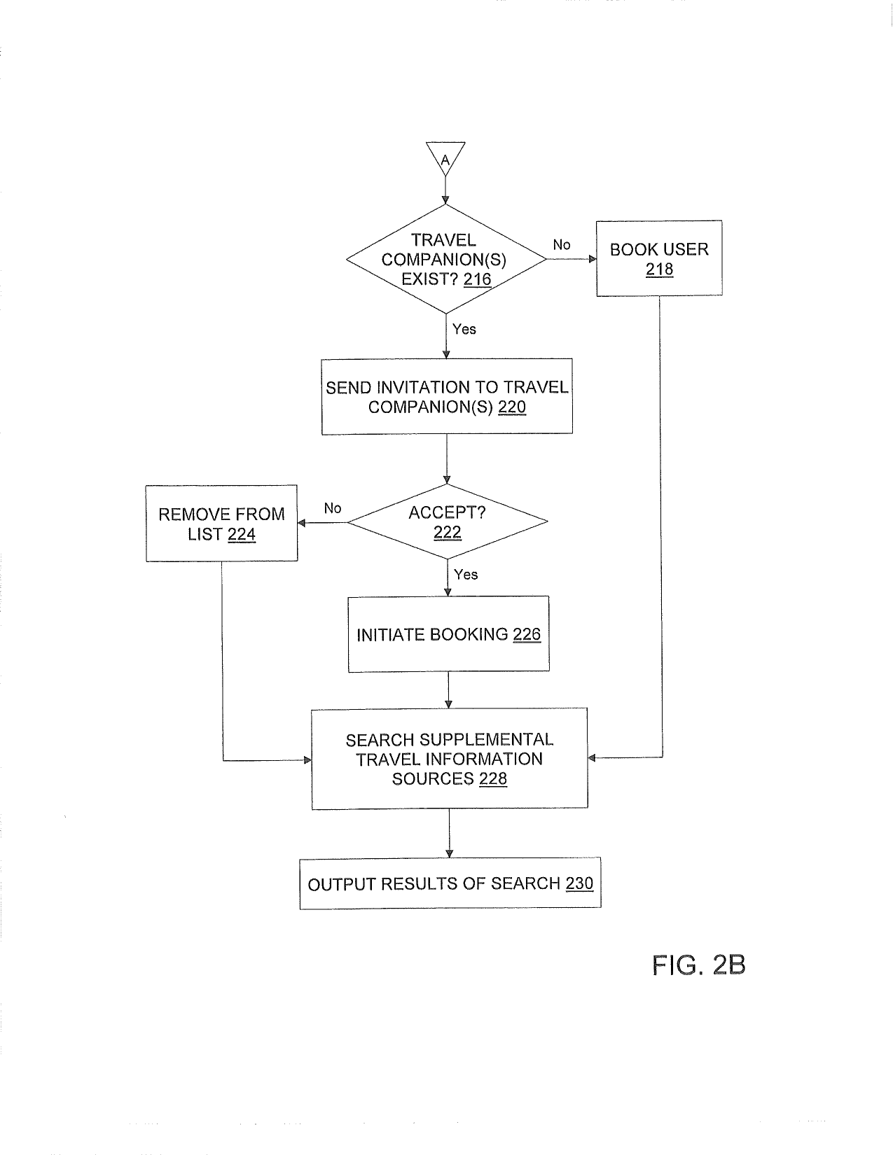

Turning now to FIGS. 2A-2B, a process for implementing a portion of the features of the information management services will now be described in an exemplary embodiment. The processes described in FIG. 2 assume that an end user has already registered or otherwise established an account (e.g., profile) for the information management services and the end user's account information is stored in the storage device 118. The set up process includes creating one or more calendar types, such as personal (private), public, or event-based, to name a few. A private calendar is viewable only by the end user, while a public calendar is viewable by any contact included in the end user's profile based on permissions granted by the end user. In one embodiment, e.g., a public calendar may list users who are all co-workers of the end user. In this example, the public calendar may be administered or managed by an employer. The public calendar may be reserved for business-related activities, events, or travel. An event-based calendar may be created for a particular event stored in the end user's calendar. The processes described in FIG. 2 are directed to booking an event (and related activities) that has been scheduled into the end user's calendar. As indicated above, the processes of FIG. 2 represent just a few of the features possible via the information management services and are presented herein by way of non-limiting examples.

The process begins when the end user accesses his/her calendar (e.g., either through the user system's 104 information manager application 112 or directly through the host system 102). At step 202, the information management engine 116 receives a selection for a trip type, which may be destination-based or event-based. In FIGS. 2A-2B, the destination-based travel processes are described in steps 204-230, while the event-based travel processes are described in steps 232-238 and 208-230.

The destination-based processes will now be described. At step 204, the end user is prompted to select a destination for the travel that has been entered into the end user's calendar, and the information management engine 116 receives the destination information. At step 206, the information management engine 116 identifies the date or dates of travel from the calendar entry. The remaining processes described for the destination-based travel are similar to those of the event-based travel and will now be described with respect to the event-based processes.

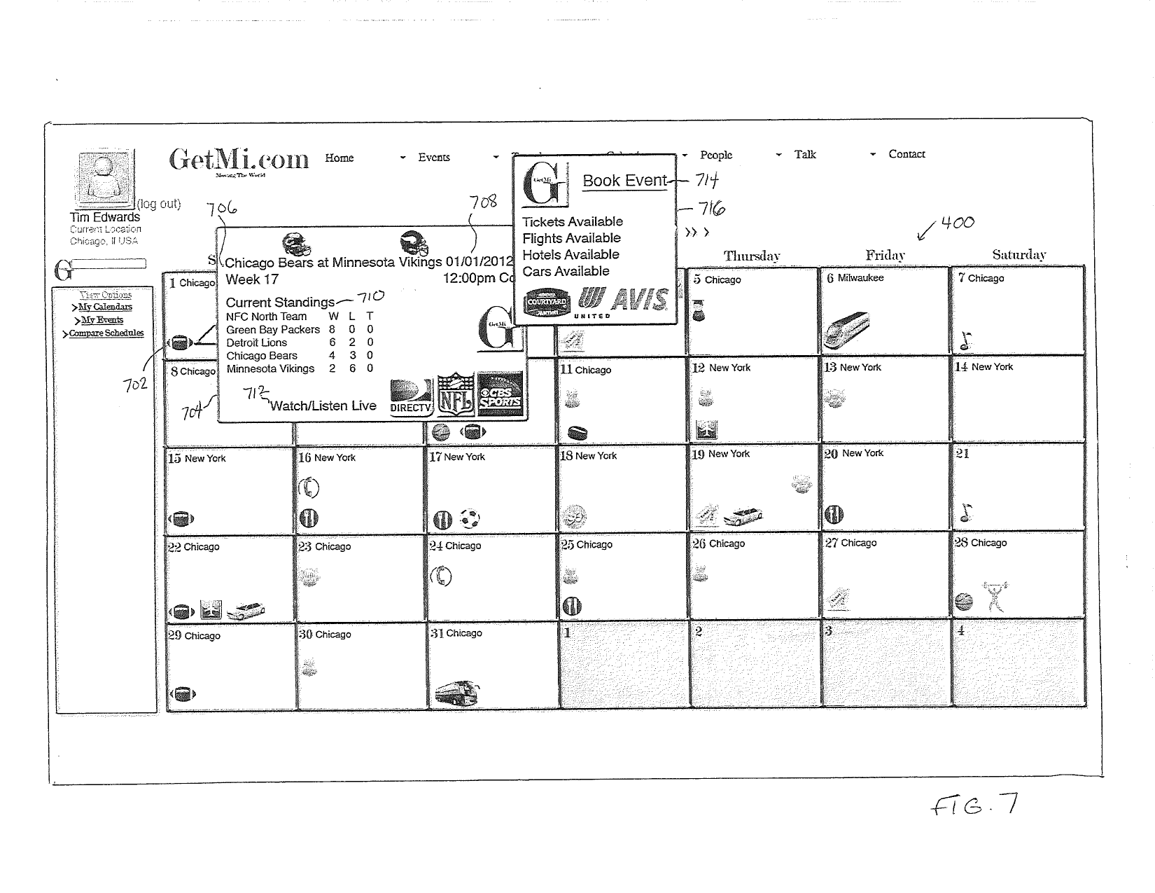

As shown in FIG. 7, the end user has accessed the calendar 400 for the month of January 2012. The end user scrolls over or selects an event icon 702 for the date “Jan. 1, 2012”, and the information management engine 116 retrieves event information related to the event icon 702 at step 232. The information management engine 116 accesses one or more third-party databases 110 (e.g., sports news database) and/or subscriber systems 108 (e.g., sporting event media provider) to search for event-related information at step 234, and displays the related information in an event window 704 of the user system 104 at step 236. As shown in FIG. 7 by way of example, the event window 704 displays the event 706 (associated with the selected event icon 702) and date and time 708 of the event 706. The event window 704 also displays current standings 710 (e.g., retrieved from the third-party database 110), as well as a link 712 to a corresponding sporting event media provider (e.g., one of the subscriber systems 108) if the event 706 is currently active.

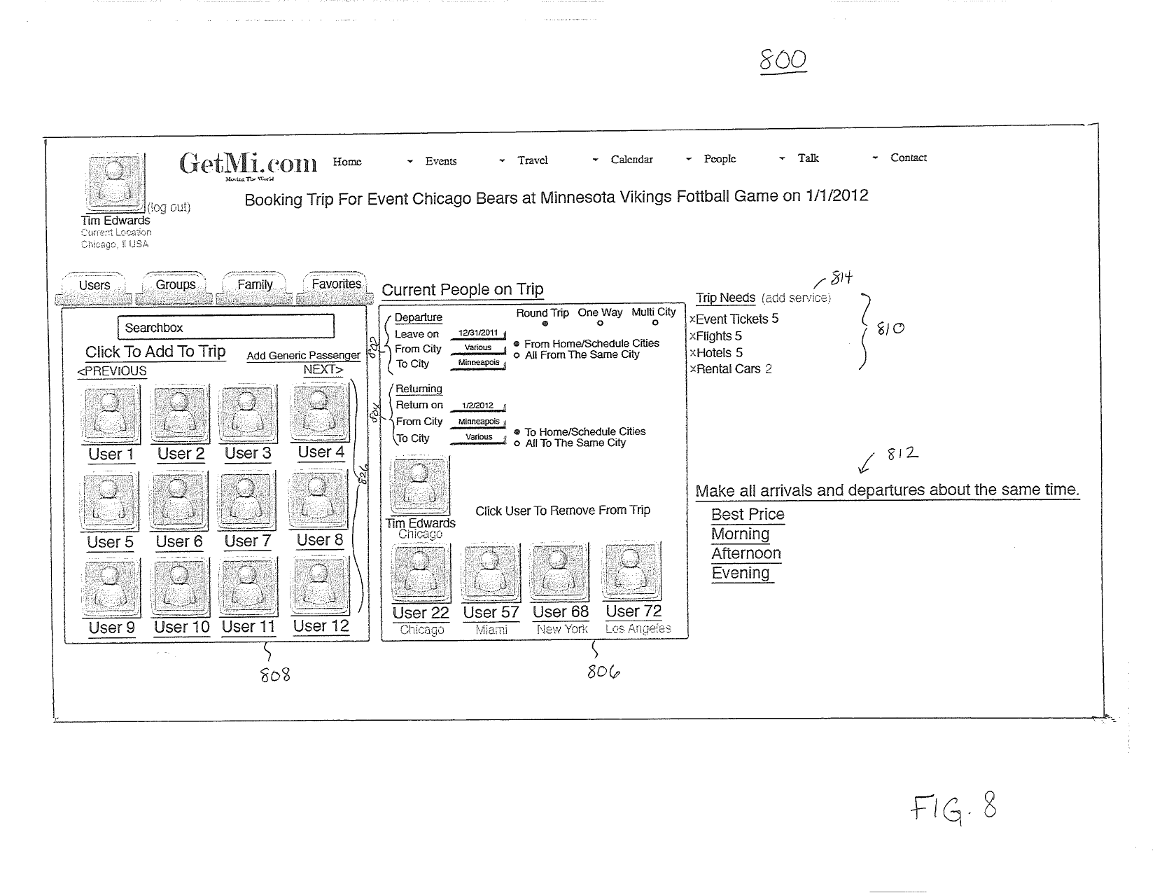

The information management engine 116 also displays a booking window 716 including a link 714 “Book Event” that, upon selection, causes the information management engine 116 to retrieve and display a user interface screen for use in booking the selected event at step 238. A sample user interface screen 800 is shown in FIG. 8.

The user interface screen 800 includes a contacts window 808 listing all of the end user's contacts. The process proceeds to step 208, whereby the end user selects or enters travel companions. For example, the end user selects one or more users 826 from the contacts window 808 and the information management engine 116 populates data from these selections into a travel booking window 806. The users selected (shown as User 22 from Chicago, User 57 from Miami, User 68 from New York, and User 72 from Los Angeles) and displayed in travel booking window 806 reflect individuals the end user will invite to the event, as described herein. The end user is prompted to enter travel information in the travel booking window 806, such as departure information 802 and return information 804. As the users selected are located in widely different areas of the United States, the departure information and the return information entered by the end user may specify “Various.” The information management engine 116 is configured to use the user preferences (see, e.g., FIG. 20) and profile information for each of the invitees in creating a search for travel resources.

The end user is also prompted to enter other services desired for the event 706. As shown in FIG. 8, service options 810 selected by the end user include a number of event tickets, a number of flights, a number of hotel reservations, and a number of rental cars needed. At any point in the booking process, the end user may select additional services by clicking on a link 814 “add service.” These additional services may include any type of assistance, benefit, or item of value to the end user. For example, additional services may include the transport of items needed for the trip (e.g., equipment), temporary storage of these items, and information and booking of excursions in the area of travel, to name a few.

Additionally, the information management engine 116 may be configured to search for flight information based on varying criteria. For example, the end user may select travel options 812 that include identifying flights for each of the invitees that are closest in time to one another, identifying flights having the best price, or flights corresponding to a time of day. Once this information has been entered, the information management engine 116 compiles the data and calculates all event, travel, and lodging needs based on the end users' selected locations and preferences at step 210 (e.g., by accessing one or more subscriber systems 108 and/or third-party databases 110, and retrieving corresponding information).

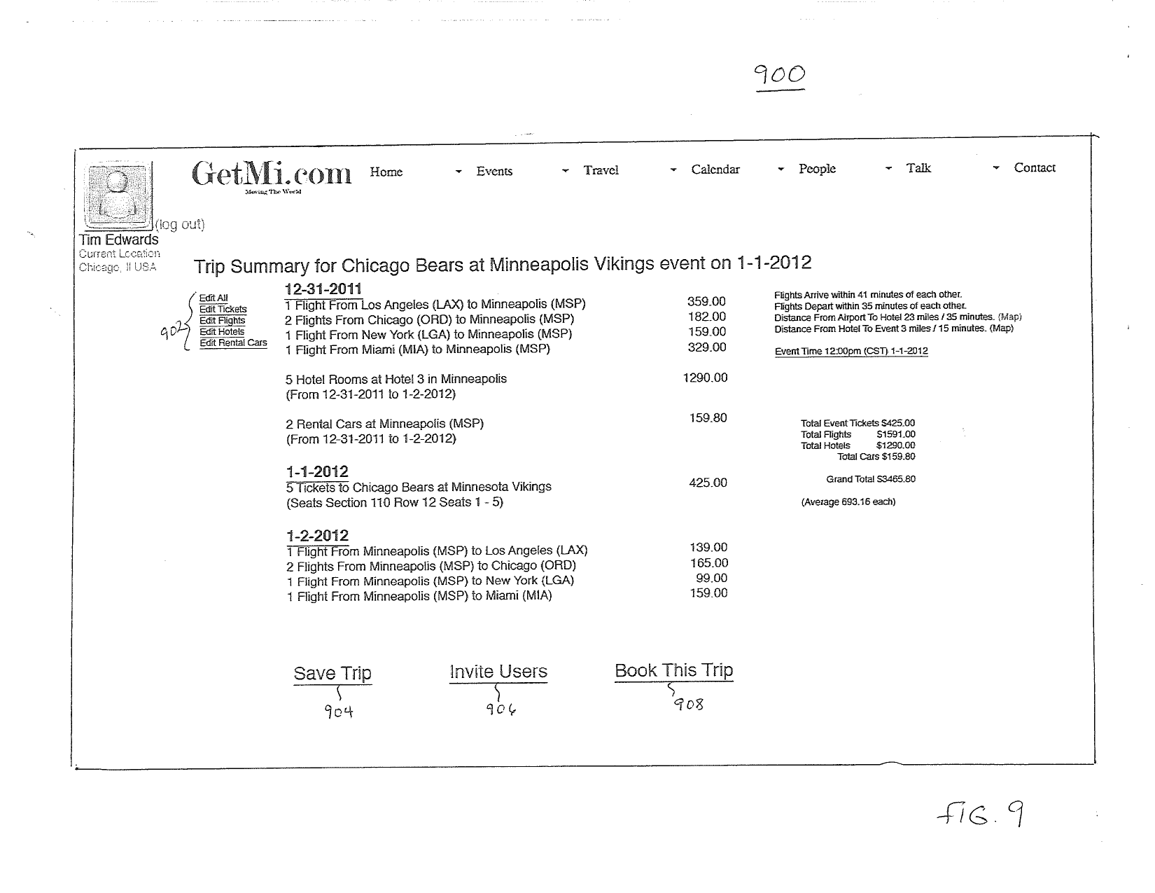

Once this processing has been completed by the information management engine 116, a trip summary is generated and displayed for the end user at step 212. As shown in FIG. 9, a user interface screen 900 depicts a sample trip summary including flights, hotel information, and rental car information with estimated costs. The trip summary may also provide a total amount of costs associated with each of the services (e.g., event, flight, hotel, car rental), as well as a grant total of the services, and an average cost per person. From this user interface 900, the end user may edit any of the selected information as desired via respective links 902 provided. The end user may then save the trip by selecting option 904, send an invitation to the selected users by selecting option 906, or book the trip by selecting option 908 at step 214.

If the end user selects option 906 (indicating travel companions exist) at step 216, the information management engine 116 generates an invitation that includes the trip summary information and sends the invitation to the invitees at step 220. Otherwise, the booking process proceeds to book the end user as a single traveler at step 218, and the process proceeds to step 228. If, however, the end user selects option 908, or alternatively, once all the invitees have accepted their invitations at step 222, the information management application 116 presents user interface screens with instructions for booking the trip. Otherwise, if any of the invitees do not accept, the invitee may be removed from the list at step 224.

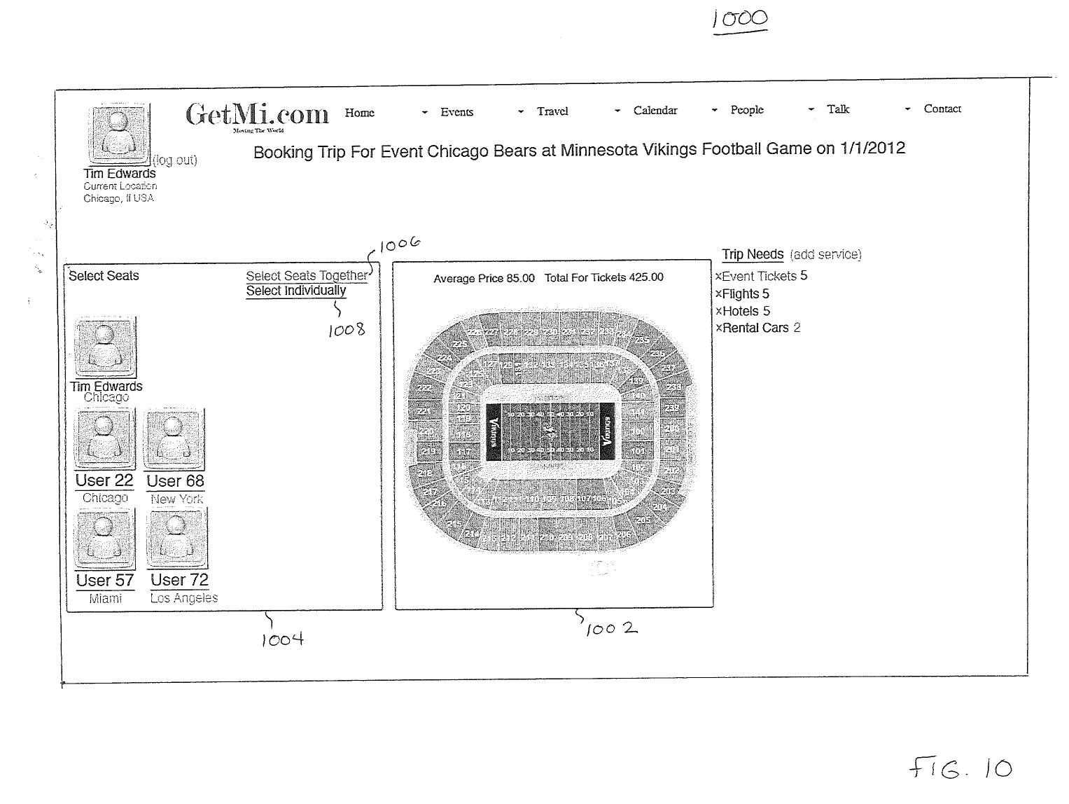

Once the end user has selected the link 908, the booking process begins at step 226. The information management engine 116 provides a user interface screen 1000, as shown in FIG. 10 to begin the booking process. The information management engine 116 accesses one of the subscriber systems 108 (e.g., event provider) for venue information relating to the event. As shown in FIG. 10, the venue information, in this example, a seating plan, is displayed in a window 1002, along with ticket pricing. A second window 1004 is populated by the information management engine 116 with the users who have accepted the invitation. An option 1006 is provided in the second window 1004 in which the end user can select seats together, which means the seating selection is indiscriminate as to which user sits in a particular seat for an available seating group. Another option 1008 is provided in which the end user can select specific individual seating assignments (e.g., Row 13, Seat AA is assigned to User 72).

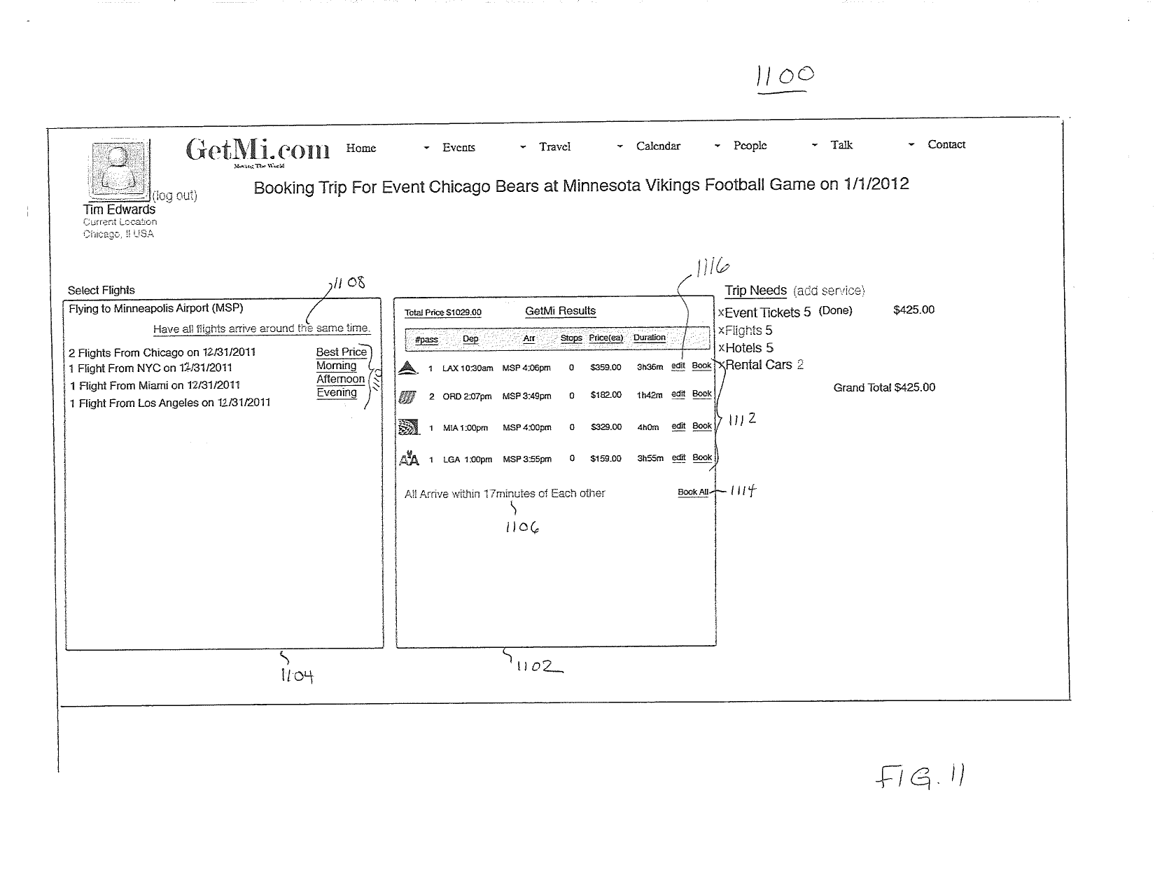

Once the end use has completed the event booking, the information management engine 116 provides a user interface screen 1100 shown in FIG. 11 that prompts the end user to book the flights for all users in the group. As shown in FIG. 11, a window 1104 provides summary information of the flight requirements for the users. The end user may select from criteria for use by the information management engine 116 in its search for flights. For example, as shown in window 1104, the end user may select an option 1108 so that the information management engine 116 will search for flights that arrive close in time to one another. Alternatively, the end user may select from options 1110 to search for best price fares or flights based on time of day. The information management engine 116 accesses one or more of the subscriber systems 108 (e.g., airline enterprises) for flight information relating to the trip based on the end user's inputs. As shown in FIG. 11, the flight information for each end user is displayed in a window 1102, along with airline name, arrival/departure information, stops, prices, and flight duration. If the end user selected an option to book flights that arrive and/or depart close together in time (e.g., the option 1108), the information management engine 116 displays this information 1106 in the window 1102. The end user may book each flight individually using links 1112 or may book all flights together via link 1114.

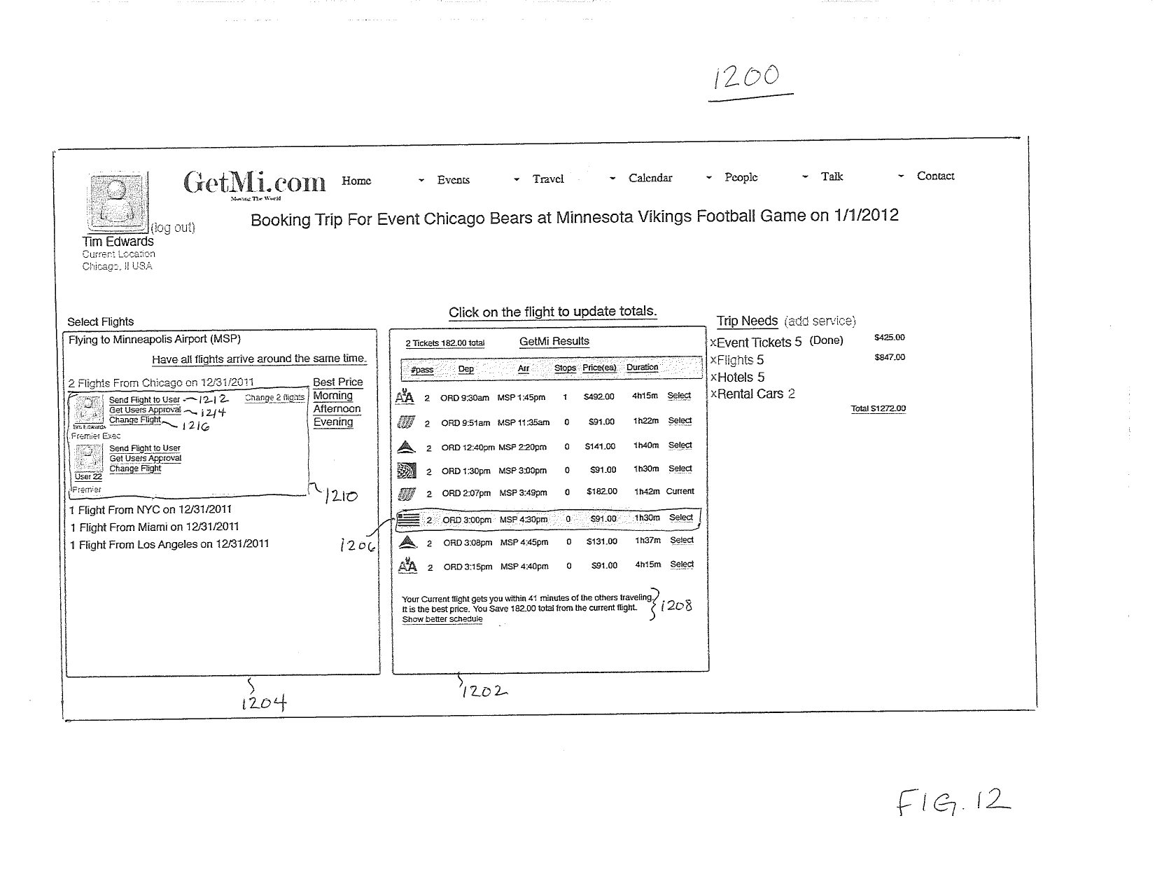

If the end user does not book each of the flights listed in the window 1102, the end user may choose to edit one or more of the flights as desired by selecting an edit link 1116 from the user interface screen 1100. By way of example, the end user selects the link 1116 corresponding to the two Chicago flights displayed in window 1102, and the information management engine 116 accesses one or more subscriber systems 108 and retrieves information for additional flights that correspond to the user preferences (e.g., premier executive, premier, etc.), a sample of which are shown in a window 1202 provided in a user interface screen 1200 of FIG. 12. The end user selects one of the alternative flights 1206 in the listing provided in window 1202, as highlighted in the Figure. The information management engine 116 uses the highlighted flight information to perform a comparative analysis of the highlighted flight and the previously selected flight, as well as a comparison of the highlighted flight to the existing booked or selected flights for the companion travelers. This information is shown generally in window 1202 at 1208.

Also shown in FIG. 12 is a window 1204 that displays the users associated with the edited flights (see subwindow 1210). The subwindow 1210 provides options as links that enable the end user to notify the respective user of the flight information (link 1212), seek approval of the edited flight from the user (link 1214), and to execute the change in flight (link 1216). Upon selecting link 1212, the information management engine 116 generates and transmits a notification of the edited flight to the user. Upon selecting link 1214, the information management engine 116 generates and transmits a request for approval to the user along with the edited flight information. Upon selecting the link 1216, the information management engine 116 executes the requested change of flight.

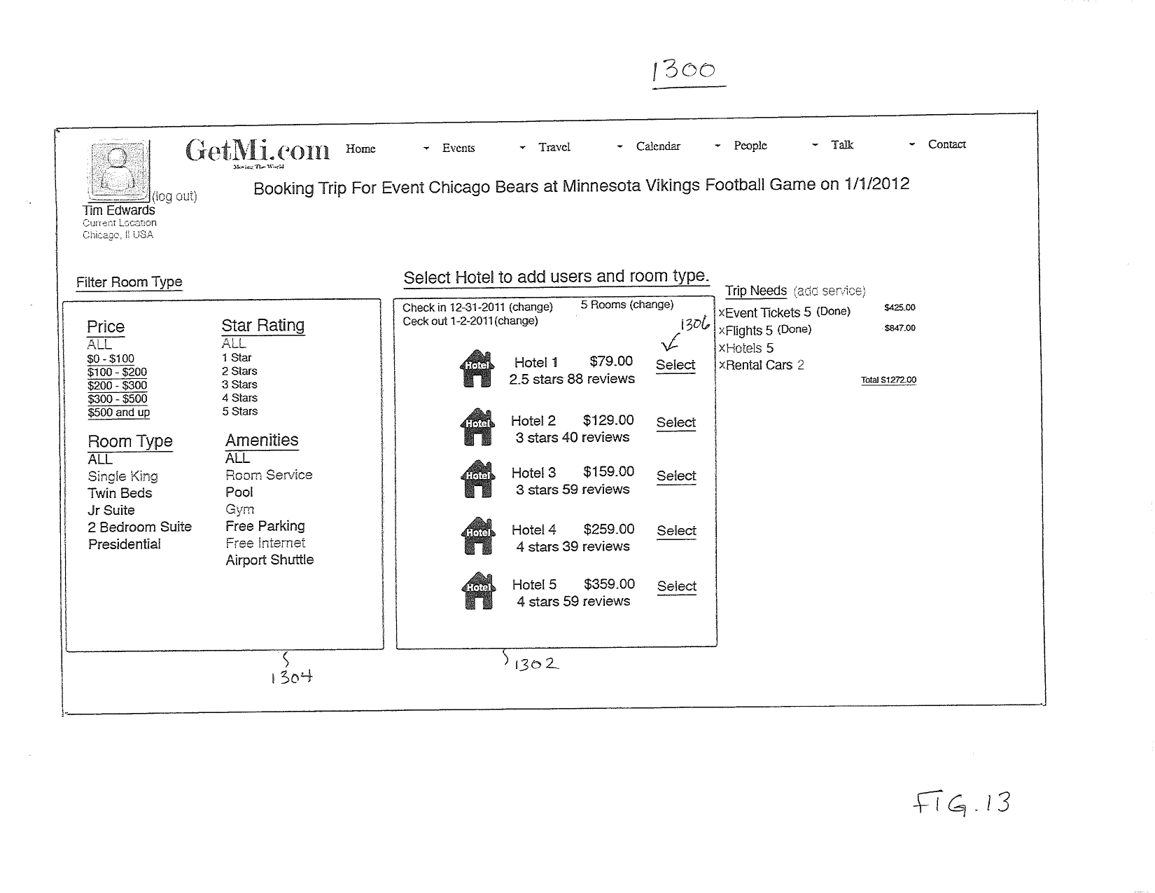

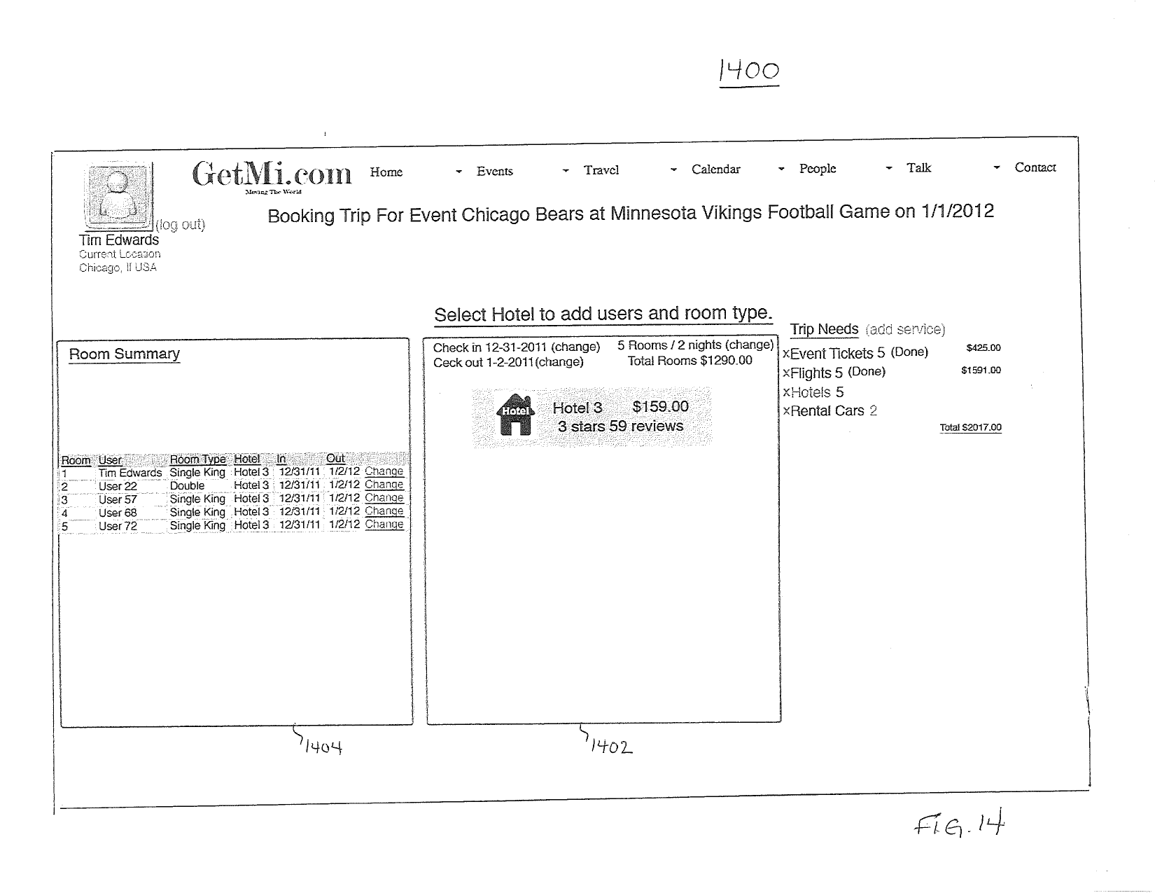

Once the flights have been booked, the information management engine 116 provides a user interface screen 1300 that enables the end user to select and book hotel rooms for the trip, as shown in FIG. 13. As shown in a window 1304, the end user is provided with several filtering criteria for enabling the information management engine 116 to conduct a search for hotels and rooms that meet the criteria. The information management engine 116 accesses one or more subscriber systems 108 for hotels and rooms that match the criteria, and the results of the search are presented in a window 1302. The end user may select the hotel from the window 1302 by clicking on a “Select” option 1306. As shown in a user interface screen 1400 of FIG. 14, e.g., the end user has selected Hotel 3 from the window 1302 of FIG. 13, and a window 1402 is displayed with hotel information, such as check in and check out dates, number of rooms and nights, hotel rating, reviews, and rates. A second window 1404 displays a room summary including room number, room type, hotel name, and check in/out information for each user in the group.

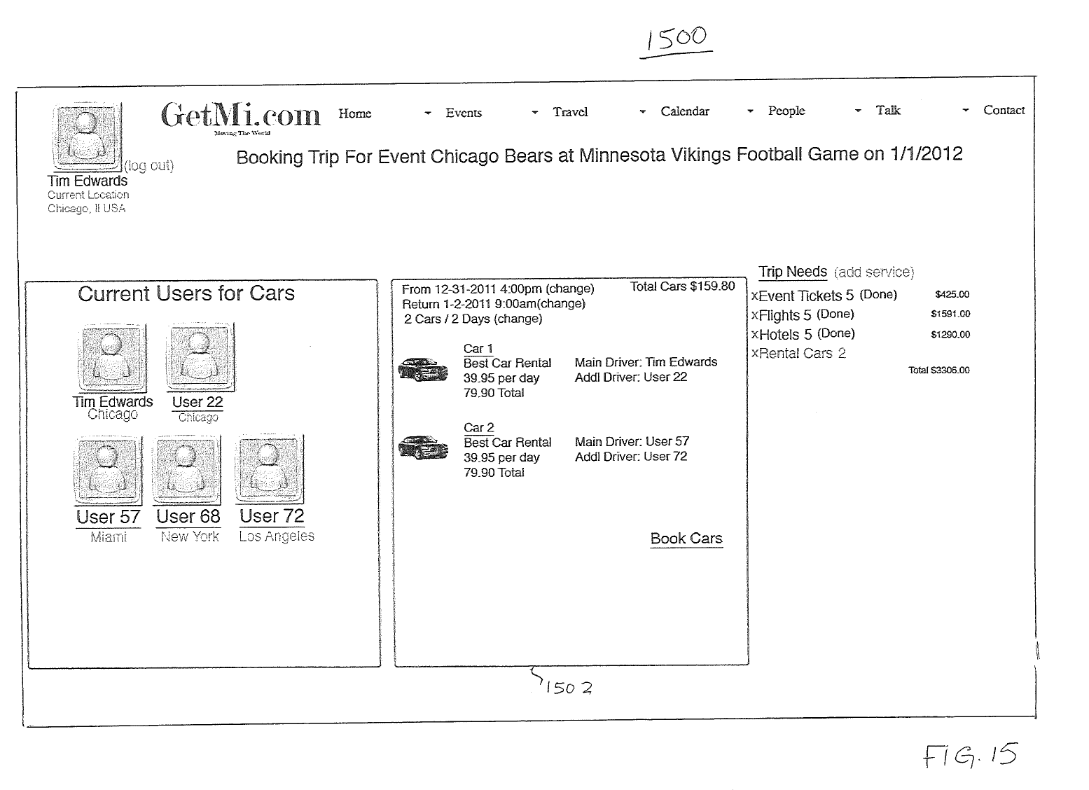

Once the hotel has been booked, the information management engine 116 provides a user interface screen 1500 that enables the end user to select and book one or more rental cars for the trip. The information management engine 116 uses user preferences and end user inputs to access one or more subscriber systems 108 (e.g., rental car agencies) and search for vehicles that meet the criteria. Sample results are shown in a window 1502 in FIG. 15. The designation of “main” and “additional” drivers may be established by accessing the user preferences (e.g., where one end user designates a preference for driving and another may prefer to be a passenger when more than one individual is booked for a vehicle rental.

It will be understood that the order in which items are booked (e.g., event, flight, hotel, and rental car) may be performed in any order. The ordering described herein is provided for illustrative purposes and is not to be construed as limiting in scope. Likewise, fewer items may be part of the booking process (e.g., no car rental), or more items and services may be part of the booking process, as desired by the end user.

At step 228, the information management engine 116 searches supplemental information sources, such as third-party databases 110 for additional related information, as described herein.

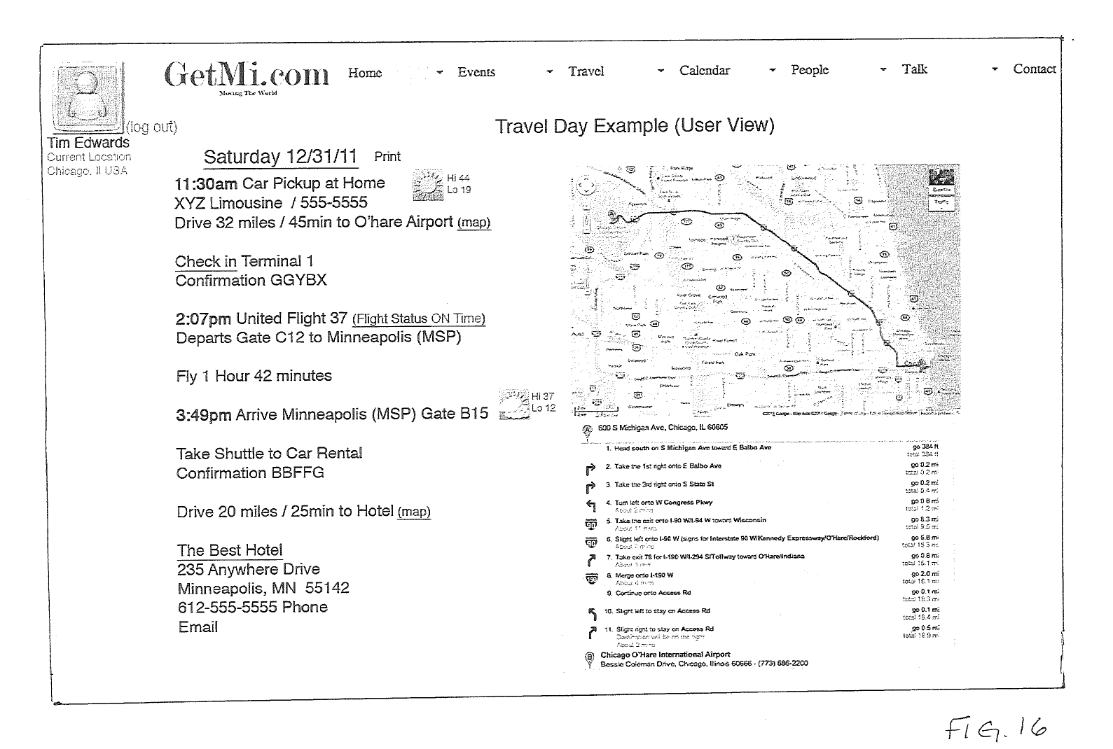

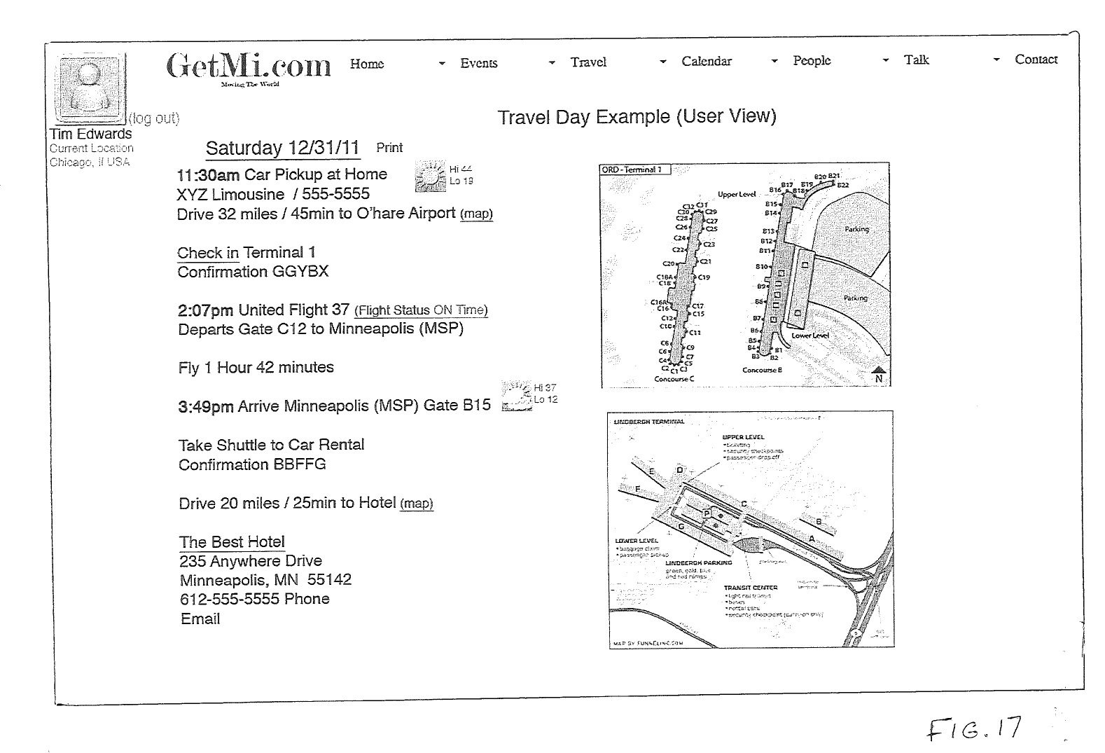

Once the items have been booked, the end user may access and view an itinerary for the trip at step 230, as shown in FIGS. 16 and 17. The information management engine 116 uses the booked information provided by the end user, accesses one or more subscriber systems 108 and/or third-party databases 110, and searches for information associated with the trip. For example, as shown in FIG. 16, travel information, such as pick up details, airline check in details, flight and shuttle information, and hotel transport information are displayed, as well as a map with driving directions to assist the driver of the rental car in getting to the hotel from the airport. Likewise, in FIG. 17, the trip information provides includes a map of the airport, airport parking, and terminal associated with the flight. As shown in both FIGS. 16 and 17, the information provided may also include a weather icon specifying high and low temperatures of the departure and arrival locations.

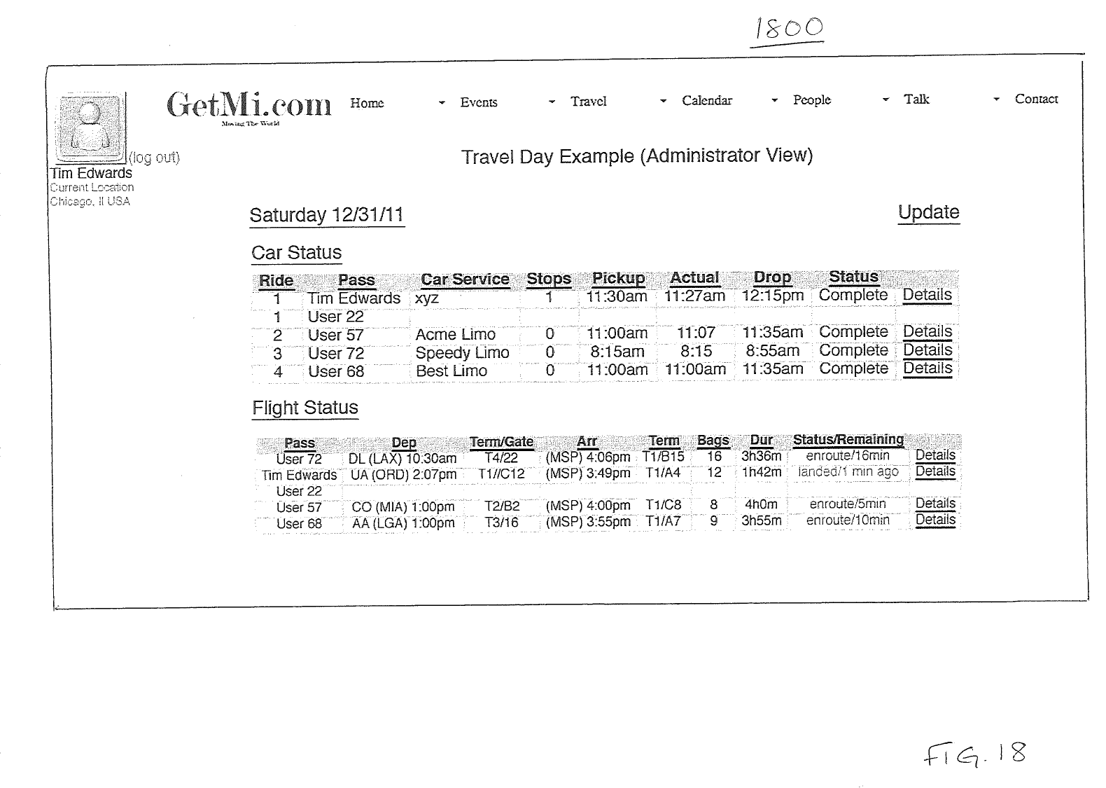

In an exemplary embodiment, the information management engine 116 is further configured to access up-to-date status information concerning the users during any point in time along the trip route. A user interface screen 1800 is shown in FIG. 18. The up-to-date information may be gathered via the information management engine 116 from various sources. For example, the information management engine 116 may receive information from a limousine driver's dispatcher, from an airline's flight schedule, or other relevant sources.

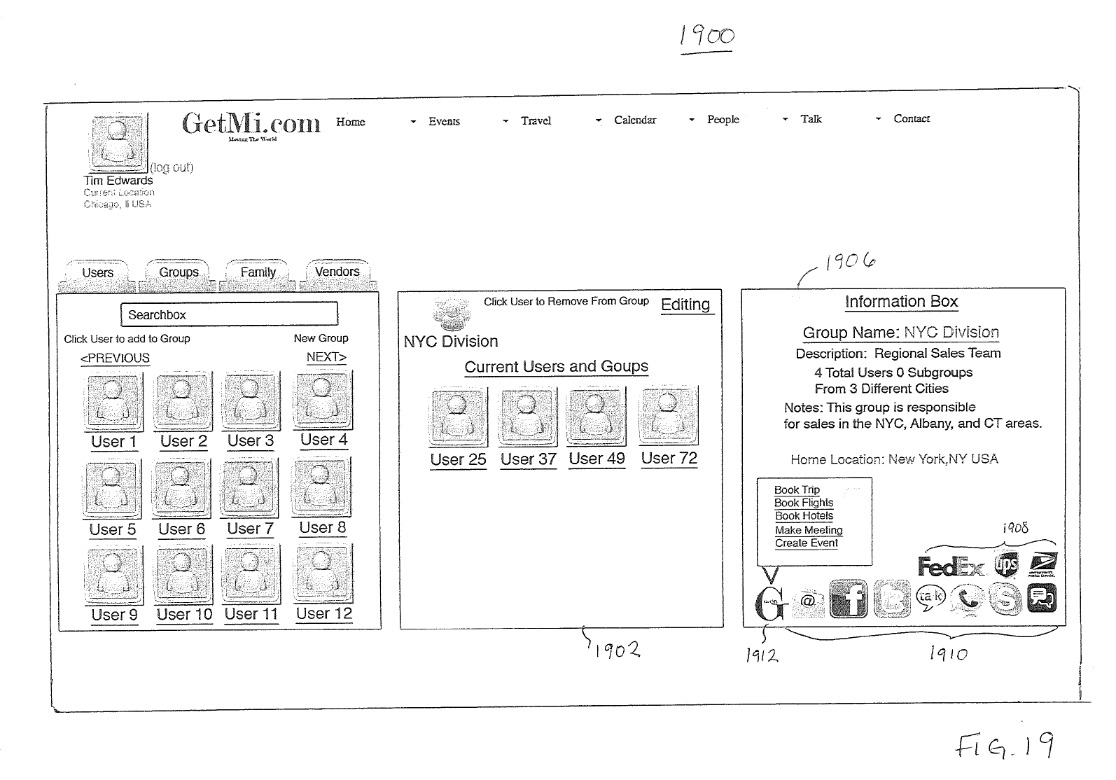

Returning now to FIG. 3, the end user can perform a number of functions in configuring users and groups. The end user can search for specific users using the search box 320. The end user may also select users or groups to add to other groups (e.g., by selecting respective icons from the users 326. If creating a new group, the end user provides a group name, as well as descriptive information about the group, if desired. A sample user interface 1900 is shown in FIG. 19. As shown in user interface screen 1900, a window 1902 lists the users selected for a group named “NYC Division.” Another window 1906 displays the information defined for the group by the end user, and the information management engine 116 displays options for performing a variety of different tasks from the window 1906, such as initiating a shipment via one of options 1908, communicating with the group via one options 1910, and tasking functions provided by the information management services via option 1912, such as booking, scheduling meetings, creating events, etc.

As indicated above, the end user may select from several user preferences, which the information management engine 116 retrieves and uses in performing the many functions enabled by the information management services. A non-limiting sample of these preferences is shown in FIG. 20. As shown in FIG. 20, sample preferences may be directed to bookings, communications, shipping, and transportation.

Technical effects of the invention include providing a comprehensive and centralized facility for planning and booking events and trips through information management services. The information management services provide a web-based user interface for guiding end users through the planning, scheduling, and reservation processes. End users can plan and book events and trips for multiple companions, or participants. The information management services offer subscription-based services to information management resource providers, such as transportation service providers, lodging providers, event providers, and related entities, such as travel agencies.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A system for implementing information management services, comprising:
a computer processor; and
logic executable by the computer processor, the logic configured to implement a method, the method comprising:
providing, via a user interface, an electronic calendar configured by an end user, along with contacts specified for the end user and selectable options;
receiving a selection of an event via the electronic calendar, the event scheduled into a date on the electronic calendar;
receiving a selection of prospective participants for the event from the contacts listed via the user interface;
accessing a database of preferences supplied by the prospective participants;
searching at least one database of event-related resources using characteristics of the event including the date of the event and the preferences of the prospective participants, and determining availability of services corresponding to the event-related resources;
selecting at least one of the event-related resources determined to have availability;
accessing contact information for the prospective participants, and transmitting an invitation to the prospective participants using the contact information, the invitation including the selected event-related resources; and
reserving the services associated with the event-related resources for the end user and each of the prospective participants who have accepted the invitation.

2. The system of claim 1, wherein the characteristics include at least one of an event name and event location.

3. The system of claim 1, wherein the logic is further configured to implement:
providing the end user with access to electronic calendars of the prospective participants, subject to approval by the prospective participants.

4. The system of claim 1, wherein the logic is further configured to implement:
receiving a request from the end user to identify contacts listed in the user interface who have scheduled events commonly shared by the end user;
using events scheduled into the electronic calendar of the end user to search for matching terms and dates in the electronic calendars of the contacts listed via the user interface; and
presenting matching scheduled events and corresponding contacts to the end user via the user interface.

5. The system of claim 1, wherein the logic is further configured to implement:
providing a link to a server providing media content associated with the event; and
accessing the server in response to selection of the link via the electronic calendar by the end user.

6. The system of claim 1, wherein the preferences include at least one of:
a preferred mode of travel;
a preferred hotel; and
a preferred mode of contact.

7. The system of claim 1, wherein the selectable options include an option requesting that any transportation booked for the prospective participants results in the prospective participants arriving at a destination within a specified period of time of one another.

8. A method for implementing information management services, comprising:
providing, via a user interface, an electronic calendar configured by an end user, along with contacts specified for the end user and selectable options;
receiving a selection of an event via the electronic calendar, the event scheduled into a date on the electronic calendar;
receiving a selection of prospective participants for the event from the contacts listed via the user interface;
accessing a database of preferences supplied by the prospective participants;
searching at least one database of event-related resources using characteristics of the event including the date of the event and the preferences of the prospective participants, and determining availability of services corresponding to the event-related resources;
selecting at least one of the event-related resources determined to have availability;
accessing contact information for the prospective participants, and transmitting an invitation to the prospective participants using the contact information, the invitation including the selected event-related resources; and
reserving the services associated with the event-related resources for the end user and each of the prospective participants who have accepted the invitation.

9. The method of claim 8, wherein the characteristics include at least one of an event name and event location.

10. The method of claim 8, further comprising:
providing the end user with access to electronic calendars of the prospective participants, subject to approval by the prospective participants.

11. The method of claim 8, further comprising:
receiving a request from the end user to identify contacts listed in the user interface who have scheduled events commonly shared by the end user;
using events scheduled into the electronic calendar of the end user to search for matching terms and dates in the electronic calendars of the contacts listed via the user interface; and
presenting matching scheduled events and corresponding contacts to the end user via the user interface.

12. The method of claim 8, further comprising:
providing a link to a server providing media content associated with the event; and
accessing the server in response to selection of the link via the electronic calendar by the end user.

13. The method of claim 8, wherein the preferences include at least one of:
a preferred mode of travel;
a preferred hotel; and
a preferred mode of contact.

14. A computer program product for implementing information management services, the computer program product comprising a storage medium embodied with computer-readable program instructions, which when executed by a computer, cause the computer to implement a method, the method comprising:
providing an electronic calendar configured by an end user, along with contacts specified for the end user and selectable options;
receiving a selection of an event via the electronic calendar, the event scheduled into a date on the electronic calendar;
receiving a selection of prospective participants for the event from the contacts listed via a user interface;
accessing a database of preferences supplied by the prospective participants;
searching at least one database of event-related resources using characteristics of the event including the date of the event and the preferences of the prospective participants, and determining availability of services corresponding to the event-related resources;
selecting at least one of the event-related resources determined to have availability;
accessing contact information for the prospective participants, and transmitting an invitation to the prospective participants using the contact information, the invitation including the selected event-related resources; and
reserving the services associated with the event-related resources for the end user and each of the prospective participants who have accepted the invitation.

15. The computer program product of claim 14, wherein the characteristics include at least one of an event name and event location.

16. The computer program product of claim 14, further comprising instructions for:
providing the end user with access to electronic calendars of the prospective participants, subject to approval by the prospective participants.

17. The computer program product of claim 14, further comprising instructions for:
receiving a request from the end user to identify contacts listed in the user interface who have scheduled events commonly shared by the end user;
using events scheduled into the electronic calendar of the end user to search for matching terms and dates in the electronic calendars of the contacts listed via the user interface; and
presenting matching scheduled events and corresponding contacts to the end user via the user interface.

18. The computer program product of claim 14, further comprising instructions for:
providing a link to a server providing media content associated with the event; and
accessing the server in response to selection of the link via the electronic calendar by the end user.

19. The computer program product of claim 14, wherein the preferences include at least one of:
a preferred mode of travel;
a preferred hotel; and
a preferred mode of contact.

20. The computer program product of claim 14, wherein the selectable options include an option requesting that any transportation booked for the prospective participants results in the prospective participants arriving at a destination within a specified period of time of one another
